(19) United States
(12) Patent Application Publication
(10) Pub. No.: US 2005/0244675 A1
(43) Pub. Date: Nov. 3, 2005

(54) Light-emitting material, electroluminescent device containing the same and method for poducing the same

(75) Inventor: Kuang-Jung Chen, Taipei (CN)

Correspondence Address: MADSON & METCALF;GATEWAY TOWER WEST, SUITE 900, 15 WEST SOUTH TEMPLE, SALT LAKE CITY, UT, 84101, US

(73) Assignee: Toppoly Optoelectronics Corp.

(21) Appl. No.: 11/117,915

(22) Filed: Apr. 29, 2005

(30) Foreign Application Priority Data
May 3, 2004 (TW) 093112417

(51) Int. Cl. B32B 19/00

(52) U.S. Cl. 428/690

(57) ABSTRACT

A light-emitting material includes a polymeric skeleton and a dye moiety. The dye moiety links to the polymeric skeleton by chemical bonding, and has an energy gap lower than that of the polymeric skeleton. As such, energy is transferred from the polymeric skeleton to the dye moiety when the light-emitting material is excited, thereby emitting light.

### FIELD OF THE INVENTION

The present invention relates to a light-emitting material, and more particularly to a light-emitting material for use in an electroluminescent device. The present invention also relates to an electroluminescent device containing a light-emitting material and a method for producing a light-emitting material.

### BACKGROUND OF THE INVENTION

Recently, electroluminescent devices become more and more attractive because of their low driving voltage, self-light-emitting feature, flexible operational temperature, high luminance, wide viewing angle, and capability of full-color emissive display.

Referring to FIG. 1, a schematic cross-sectional view of a typical electroluminescent device is shown. The electroluminescent device 1 comprises a transparent substrate 10 having thereon a multilayer structure including a transparent anode 11, an electric hole transport layer (HTL) 12, a light-emitting material layer (EML) 13, an electron transport layer (ETL) 14 and a cathode 15. Depending on the desired application, each layer of the multilayer structure can be selected from various materials. For example, the transparent anode 11 is made of a transparent conducting material such as indium tin oxide (ITO). Examples of the hole-transporting materials that can be utilized in the electric hole transport layer 12 include polyethylene dioxythiophene (PEDOT), polyaniline (PANI), etc. The electron transport layer 14 is preferably made of a material matching the energy level of the emitting material layer 13. The cathode 15 can be made of any suitable metal. Depending on the material of the emitting material layer 13, electroluminescent device are typically classified into two types, i.e. an organic light emitting device (OLED) and a polymeric light emitting device (PLED). In the case of the organic light emitting device, the light-emitting material layer 13 is made of a low molecular organic compound or a metal oxinoid compound. On the other hand, in the case of the polymeric light emitting device, the light-emitting materials are polymers.

In a conventional organic light emitting device (OLED), the organic light-emitting material that can be utilized in the light-emitting material layer 13 includes a fluorescent substance, e.g. tris(8-quinolinolato) aluminum (Alq3), as the host, and [10-(2-benzothiazolyl)-2,3,6,7-tetrahydro-1,1,7,7-tetramethyl-1H,5H, 11H-[1]benzopyrano[6,7,8-ij]quinolizin-11-one] (C545T), as the dopant. The light-emitting material layer 13 is deposited by evaporation, for example. As is known in the art, according to the evaporation process, the low molecular organic light-emitting materials are thermally vaporized and then deposited on a target surface. Since the vaporized materials may also be deposited on the wall of the reaction chamber or other places, the utilization ratio thereof is considerably low, or even lower than 10%. Although the resulting light-emitting material layer has high emissive color purity, their physical properties are not satisfied, for example the thermal stability is poor and the mechanical strength is low. In addition, it is found that the organic light-emitting materials of low molecular weight may be re-crystallized during the repeated cycles of heating and cooling treatments. As such, the light-emitting material layers made of these organic light-emitting materials would be degraded.

On the other hand, the electroluminescent compounds generally used in the PLEDs are polymers or oligomers such as polyfluorene, which are applied onto a target surface by a spin coating or an ink-inject printing process. As known, according to the spin coating or the ink-inject printing process, the utilization ratio for the polymeric materials can be increased up to 90%. These polymeric materials are suitable for preparation of thin films with good thermal stability and sufficient mechanical strength. However, due to broad distribution of molecular weights, the half-width of the polymeric material is wider than that of the low molecular-weight organic material, and its color purity and color reproduction are not satisfactory.

In order to overcome the above drawbacks and achieve excellent thermal stability and illuminant feature, the low molecular-weight dye can be directly mixed with and dispersed in a polymeric material, and the resulting mixture is then applied onto the target surface. However, if the low molecular-weight dye is not uniformly distributed in the polymeric material, the mixture may be re-crystallized during the repeated cycles of heating and cooling treatments, so as to degrade the resulting light-emitting material layers.

### SUMMARY OF THE INVENTION

The present invention provides a light-emitting material for use in an electroluminescent device, which has good thermal stability and sufficient mechanical strength, and is capable of avoiding the re-crystallizing problem. The present invention further provides a process for producing the light-emitting material.

The present invention also provides an electroluminescent device containing the light-emitting material of good property so as to enhance the color purity and color reproduction thereof.

The present invention provides a light-emitting material, comprising a polymeric skeleton; and a dye moiety linking to the polymeric skeleton by chemical bonding, and having an energy gap lower than that of the polymeric skeleton so that energy is transferred from the polymeric skeleton to the dye moiety when the light-emitting material is excited, thereby the light-emitting material emits light.

In an embodiment, the dye moiety links to a terminal of the polymeric skeleton by coupling.

In an embodiment, the polymeric skeleton comprises a polymeric or oligomeric fluorene.

For example, the polymeric skeleton comprises a repeating unit of the formula: 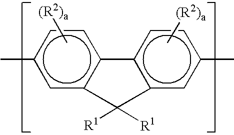
wherein R¹ is independently, in each occurrence, C₁₋₂₀ hydrocarbyl or C₁₋₂₀ hydrocarbyl containing one or more S, N, O, P or Si atoms, or both of R¹, together with the 9-carbon on the fluorene, may form a C₅₋₂₀ ring structure or a C₄₋₂₀ ring structure containing one or more S, N, or O atoms;
R² is independently, in each occurrence, C₁₋₂₀ hydrocarbyl, C₁₋₂₀ hydrocarbyloxy, C₁₋₂₀ thioether, C₁₋₂₀ hydrocarbyloxycarbonyl, C₁₋₂₀ hydrocarbylcarbonyloxy, or cyano; and
a is independently, in each occurrence, 0 or 1.

In an embodiment, R¹ is C₁₋₂₀ hydrocarbyl. For example, R¹ is n-octyl, and a is 0.

In an embodiment, the polymeric skeleton is polyparaphenylene (PPP).

In an embodiment, the dye moiety is a radical comprising a dye selected from the group consisting of:

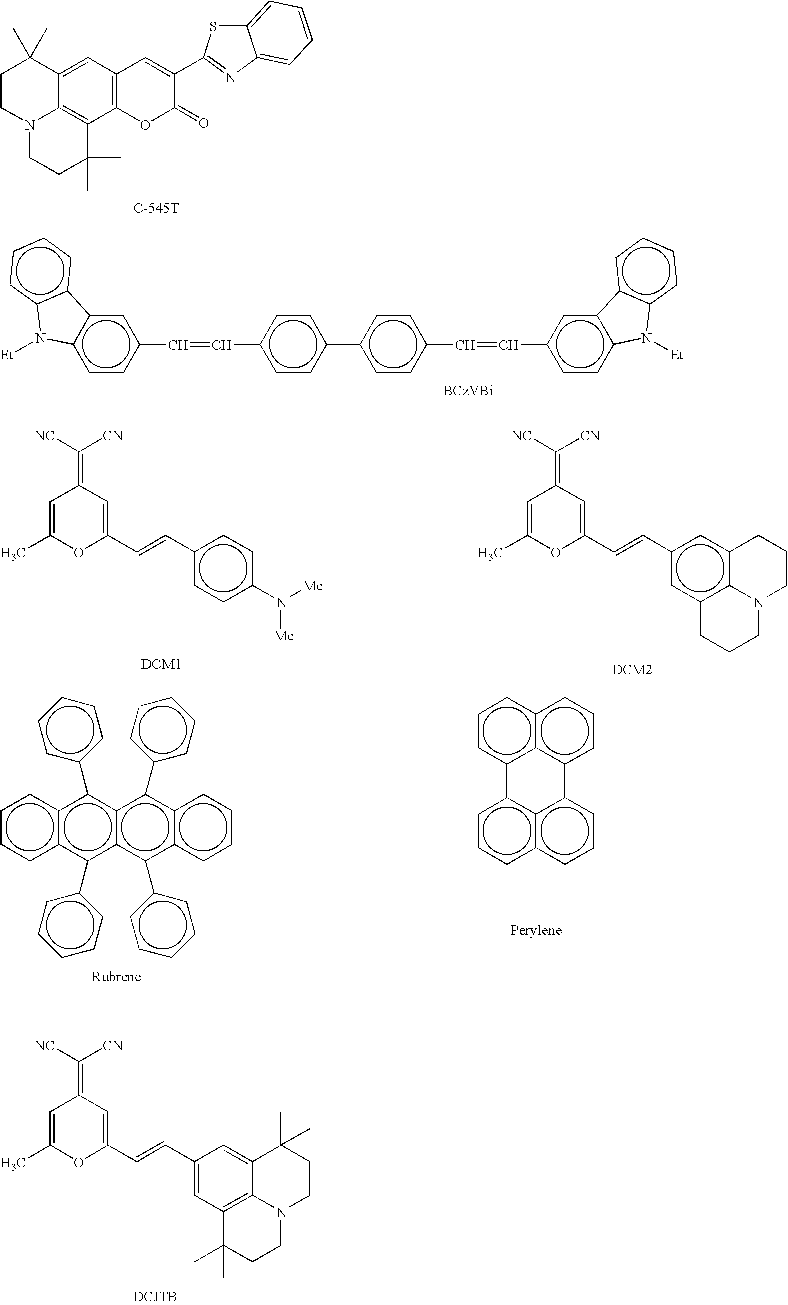

According to an embodiment, the dye moiety can be

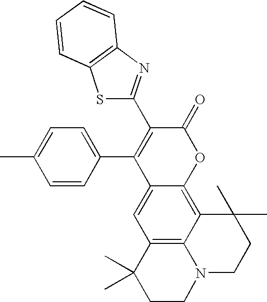

The present invention also provides an electroluminescent device. The electroluminescent device comprises a light transmissible electrode pair comprising an anode and a cathode; an electric hole transport layer disposed between the anode and the cathode, and adjacent to the anode; an electron transport layer disposed between the anode and the cathode, and adjacent to the cathode; and a light-emitting material layer disposed between the anode and the cathode. The light-emitting material comprises a polymeric skeleton; and a dye moiety linking to the polymeric skeleton, and having an energy gap lower than that of the polymeric skeleton so that energy is transferred from the polymeric skeleton to the dye moiety when the light-emitting material is excited, thereby the light-emitting material emits light.

The present invention further provides a process for producing a light-emitting material, comprising steps of providing a dye molecule; modifying the dye molecule to have a first terminal reactive group; providing a monomer having a second terminal reactive group; polymerizing the monomer to produce a polymer having the second terminal reactive group; and reacting the modified dye molecule with the polymer by a reaction of the first terminal reactive group and the second terminal reactive group to produce a light-emitting material comprising a polymeric skeleton and a dye moiety linking to the polymeric skeleton.

For example, the dye molecule can be selected from the group consisting of

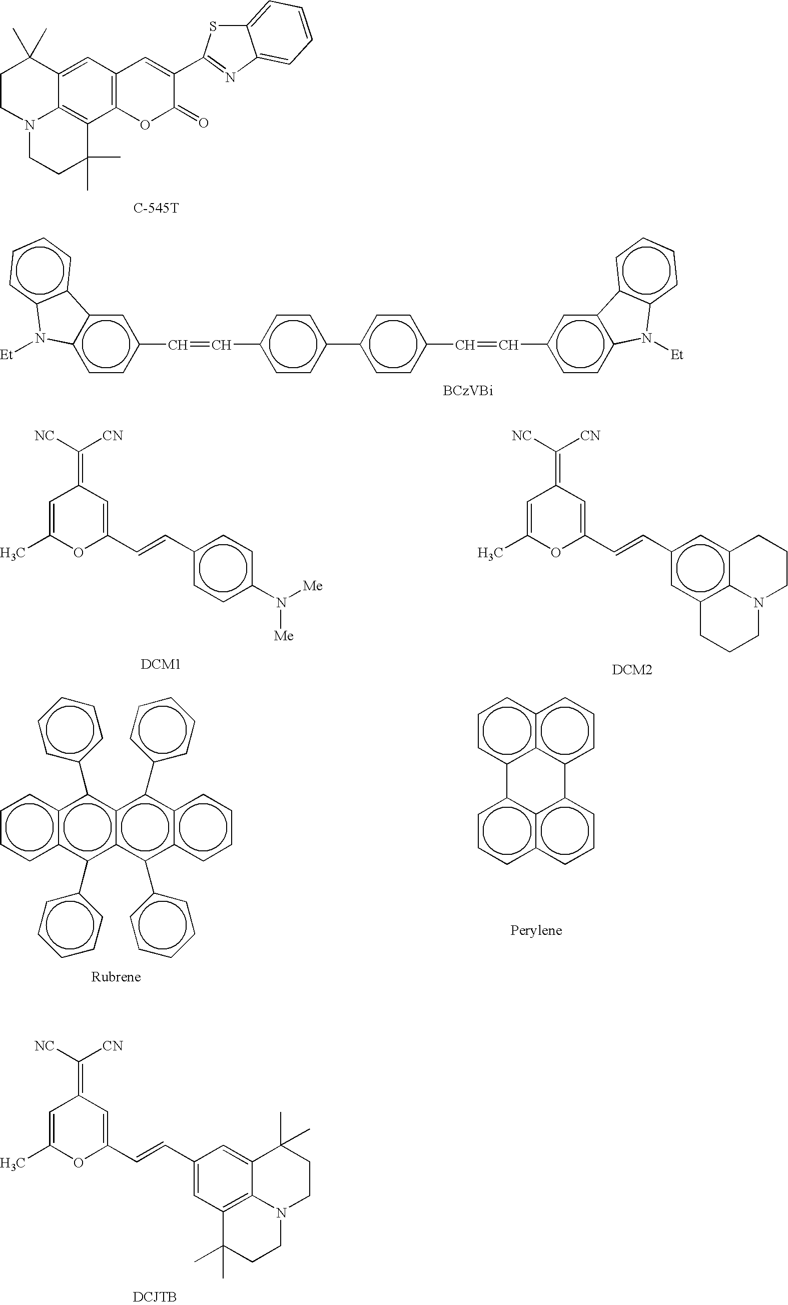

In an embodiment, the first terminal reactive group comprises halogen.

In an embodiment, the monomer is 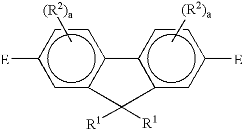
wherein R¹ is independently, in each occurrence, C₁₋₂₀ hydrocarbyl or C₁₋₂₀ hydrocarbyl containing one or more S, N, O, P or Si atoms, or both of R¹, together with the 9-carbon on the fluorene, may form a C₅₋₂₀ ring structure or a C₄₋₂₀ ring structure containing one or more S, N, or O atoms;
R² is independently, in each occurrence, C₁₋₂₀ hydrocarbyl, C₁₋₂₀ hydrocarbyloxy, C₁₋₂₀ thioether, C₁₋₂₀ hydrocarbyloxycarbonyl, C₁₋₂₀ hydrocarbylcarbonyloxy, or cyano;
a is independently, in each occurrence, 0 or 1; and
E is independently a second terminal reactive group.

For example, E is halogen.

In an embodiment, R¹ is C₁₋₂₀ hydrocarbyl, and the monomer is 2,7-dibromo-9,9-di-n-octylfluorene.

In an embodiment, the polymer is a polyparaphenylene (PPP) having a second terminal reactive group.

In an embodiment, the emission wavelength of the polymer is shorter than that of the dye molecule.

The contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view of a typical electroluminescent device;

FIG. 2 illustrates a fluorescent spectrum of poly(9,9-di-n-octylfluorene-2,7″-diyl); and

FIG. 3 is a fluorescent spectrum of C545TP-capped poly(9,9-di-n-octylfluorene-2,7″-diyl) prepared according to an embodiment of the present invention.

### DETAILED DESCRIPTION OF THE PREFERRED EMBODIMENT

In the synthesis process of organic electroluminescent polymeric materials such as polyfluorene-based polymeric compounds, an end capping reaction is carried out via a terminal aromatic group. Meanwhile, the residual halides (e.g. bromide) resulting from the polymeric terminal reaction are removed to inhibit or reduce the occurrence of the excimer emission. In general, the introduction of the terminal aromatic group does not result in the change of the emissive color of the polymeric material. In other words, the half width of fluorescent spectrum of such an electroluminescent polymeric material is still narrower than that of the low molecular-weight light-emitting material. Therefore, the emissive color purity of the electroluminescent polymeric material is not as good as that of the low molecular-weight light-emitting material.

According to certain embodiments of the present invention, a dye molecule is utilized to perform the end capping reaction, thereby preparing a light-emitting material having a polymeric skeleton and a terminal dye moiety. The dye moiety links the polymeric skeleton by chemical bonding. The light-emitting material utilizes energy gap differences between a low molecular-weight organic compound (for example, a dye) and a polymeric or oligomeric material to result in color change. The polymer has a higher energy gap, and the dye used for modification has a lower energy gap. By modifying various polymeric skeletons with various dye molecules on the terminal positions, various light-emitting materials with different emission colors can be produced. When the light-emitting material is excited, for example, by UV light, energy is transferred from its polymeric skeleton to its terminal dye moiety so as to emit light.

According to certain embodiments of the present invention, the dye moiety links to a terminal of the polymeric skeleton, for example, by coupling.

According to certain embodiments of the present invention, the polymeric skeleton comprises a polymeric or oligomeric fluorene. The polymeric skeleton can comprise a repeating unit of the formula: 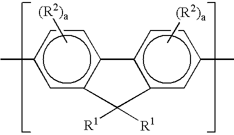
wherein R¹ is independently, in each occurrence, C₁₋₂₀ hydrocarbyl or C₁₋₂₀ hydrocarbyl containing one or more S, N, O, P or Si atoms, or both of R¹, together with the 9-carbon on the fluorene, may form a C₅₋₂₀ ring structure or a C₄₋₂₀ ring structure containing one or more S, N, or O atoms;
R² is independently, in each occurrence, C₁₋₂₀ hydrocarbyl, C₁₋₂₀ hydrocarbyloxy, C₁₋₂₀ thioether, C₁₋₂₀ hydrocarbyloxycarbonyl, C₁₋₂₀ hydrocarbylcarbonyloxy, or cyano; and
a is independently, in each occurrence, 0 or 1.

In an embodiment, R¹ is C₁₋₂₀ hydrocarbyl, e.g. n-octyl, and a is 0. In another embodiment, the polymeric skeleton can be polyparaphenylene (PPP).

On the other hand, the dye moiety can be a radical comprising a dye selected from the group consisting of:

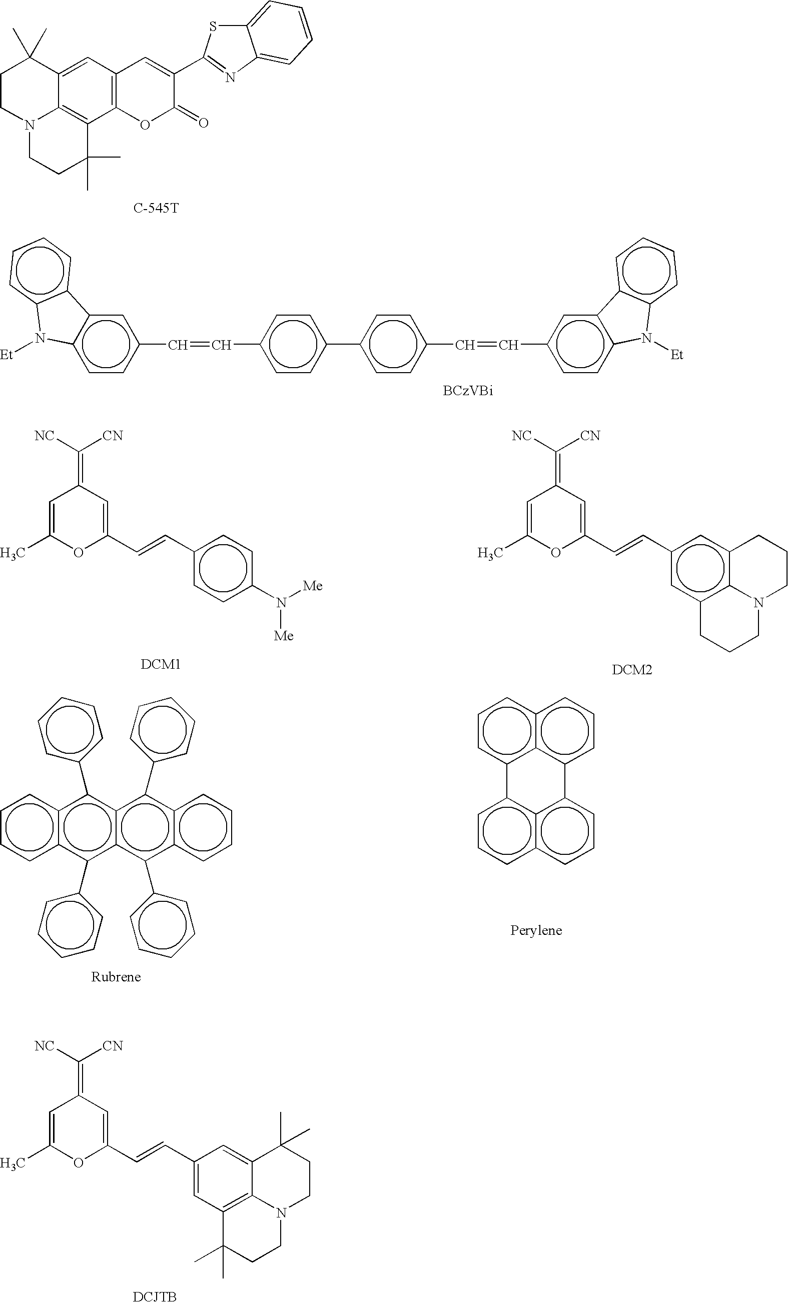

In an embodiment, the dye moiety is

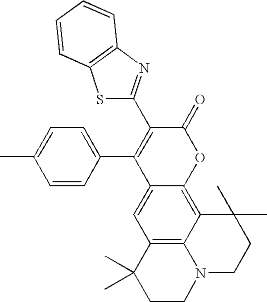

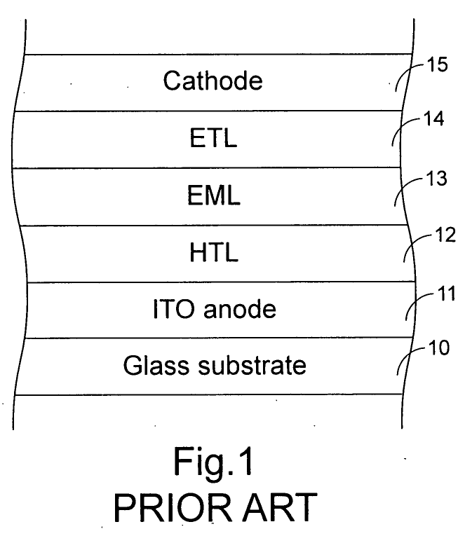

With the above light-emitting material, an electroluminescent device according to the present invention, as shown in FIG. 1, can be made, comprising a light transmissible electrode pair comprising an anode 11 and a cathode 15; an electric hole transport layer 12 disposed between the anode 11 and the cathode 15, and adjacent to the anode 11; an electron transport layer 14 disposed between the anode 11 and the cathode 15, and adjacent to the cathode 15; and a light-emitting material layer 13 disposed between the anode 11 and the cathode 15. The light-emitting material 13 can comprise a polymeric skeleton and a dye moiety linking to the polymeric skeleton, as described and exemplified above, and having an energy gap lower than that of the polymeric skeleton so that energy is transferred from the polymeric skeleton to the dye moiety when the light-emitting material is excited, thereby the light-emitting material emits light.

According to certain embodiments of the present invention, the process for producing the light-emitting material is described below.

First, a dye molecule is provided and modified to have a first terminal reactive group. Meanwhile, a monomer having a second terminal reactive group is provided and polymerized to produce a polymer having the second terminal reactive group. The modified dye molecule is then reacted with the polymer by a reaction of the first terminal reactive group and the second terminal reactive group to produce a light-emitting material comprising a polymeric skeleton and a dye moiety linking to the polymeric skeleton.

For example, the dye molecule can be selected from the group consisting of

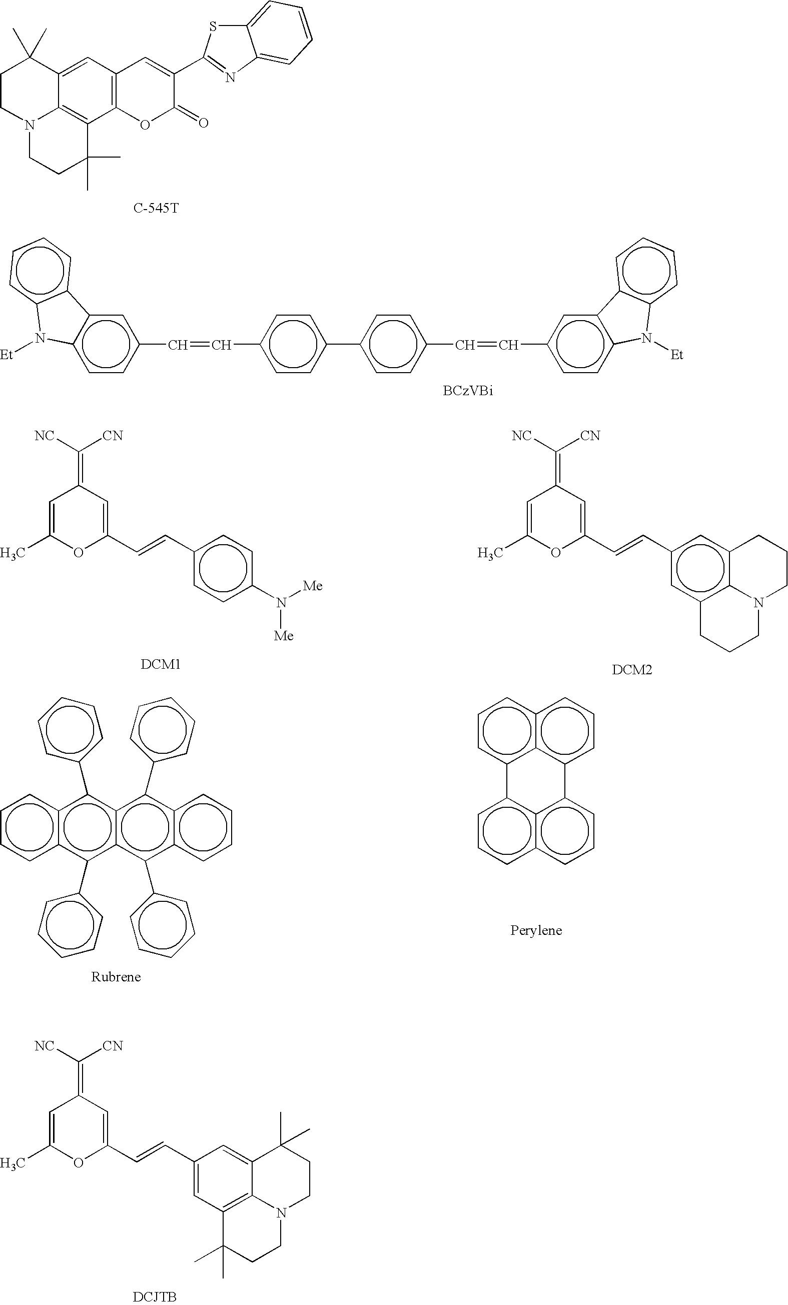

In an embodiment, the first terminal reactive group comprises halogen. The monomer is 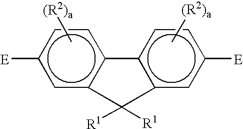
wherein R¹ is independently, in each occurrence, C₁₋₂₀ hydrocarbyl or C₁₋₂₀ hydrocarbyl containing one or more S, N, O, P or Si atoms, or both of R¹, together with the 9-carbon on the fluorene, may form a C₅₋₂₀ ring structure or a C₄₋₂₀ ring structure containing one or more S, N, or O atoms;
R² is independently, in each occurrence, C₁₋₂₀ hydrocarbyl, C₁₋₂₀ hydrocarbyloxy, C₁₋₂₀ thioether, C₁₋₂₀ hydrocarbyloxycarbonyl, C₁₋₂₀ hydrocarbylcarbonyloxy, or cyano;
a is independently, in each occurrence, 0 or 1; and
E is independently a second terminal reactive group, e.g. halogen.

In an embodiment, R¹ is C₁₋₂₀ hydrocarbyl, the monomer is 2,7-dibromo-9,9-di-n-octylfluorene. In another embodiment, the polymer is a polyparaphenylene (PPP) having a second terminal reactive group. The emission wavelength of the polymer is shorter than that of the dye molecule.

The polymer having the second terminal reactive group can be prepared according to the conventional methods for producing polyfluorene derivatives, for example described in U.S. Pat. Nos. 6,353,083; 6,255,449; 6,255,447; 6,169,163; 5,962,631; 5,708,130 and 5,545,760, which are incorporated herein for reference.

According to certain embodiments of the present invention, the energy gap difference between the polymer and the dye molecule can be in a confined range, for example, between green and red, blue and green, or deep blue and pale blue, in order that energy transfer can be successfully performed. For example, when a green light emitting polymer is used, a red light emitting dye, such as 4-(dicyanomethylene)-2-I-propyl-6-(1,1,7,7-tetramethyljulolidyl-9-enyl)-4H-pyran (DCJTB), can be used for modification. For example, when a blue light emitting polymer is used, a green light emitting dye, such as C545T, can be used for modification. Furthermore, according to certain embodiments of the present invention, the light emitting material after modification exhibits both excellent thermal stability and high color purity, which are attributed to the polymeric skeleton and the dye molecule, respectively. Since the dye moiety links to the polymeric skeleton via a chemical reaction, the resulting light-emitting material can be exempted from re-crystallization during storage and in use.

The following examples are included for illustrative purposes only and do not intend to limit the scope of the present invention.

### EXAMPLES

### Example 1

### Preparation of the dye molecule C545TPBr

As shown in the following reaction scheme, zinc chloride was added to a solution of the reactants (a) and (b) in ethanol in order to obtain the compound (c). Subsequently, the compound (c) was dissolved in dimethyl form amide (DMF), and phosphorus oxychloride (POCl₃) was added into the mixture of compound (c) and DMF in an ice bath, thereby forming a compound (d). The compound (d) was then dissolved in para-toluene sulphonic acid (PTSA)/toluene, and reacted with compound (e) so as to yield a product (f), i.e. the modified dye C545TPBr (C545T phenyl bromide).

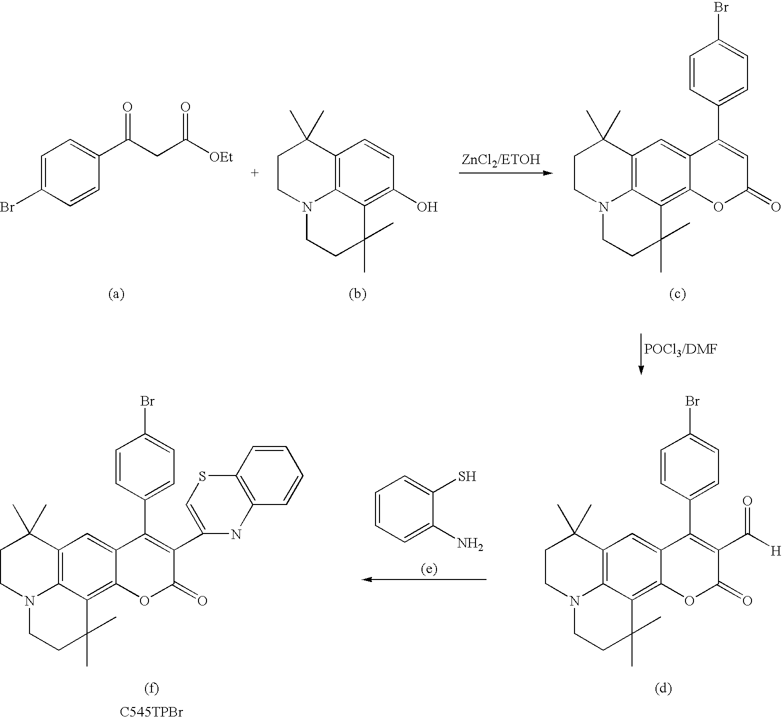

### Example 2

### Preparation of poly(9,9-di-n-octylfluorene-2,7″-diyl)

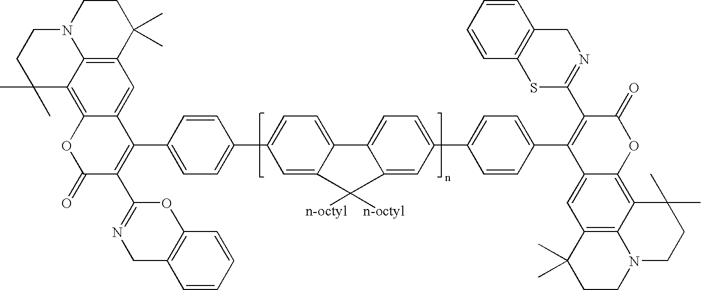

A monomer 2,7-dibromo-9,9-di-n-octylfluorene (4.03 g, 10.0 mmol), a nickel chloride-2,2-bipyridine-complex (43 mg, 0.15 mmol), a powered zinc (1.96 g, 30 mmol) and triphenylphosphine (TPP) (1.31 g, 30 mmol) were mixed in a reactor. Under nitrogen atmosphere, 10 ml of dry dimethylacetamide (DMAc) was added and the contents of the reactor were heated at 80° C. After about 4 hours, a solid polymer was formed and the temperature of the reaction solution was raised to 90° C. over a period of about 6 hours. Subsequently, 10 ml of dry toluene was added and the reaction was continued. In order to prevent fully evaporation of the solvent, additional toluene could be added. As the polymerization proceeded, the molecular weight of the polymer was increased.

### Example 3

### Preparation of C545TP-capped poly(9,9-di-n-octylfluorene-2,7″-diyl)

Depending on the required molecular weight, the polymerization reaction described in Example 2 was repeated for a desired time period, for example 14 hours. The modified dye C545TPBr (3.0 mmol) prepared in the example 1 was dissolved in 10 ml of DMF and added to the reactor. Under nitrogen atmosphere, the content was reacted at 80° C. for 24 hours. The reaction mixture was dissolved in toluene and filtered, and the filtrate was washed with water. The toluene solution was stirred at room temperature with 2 ml of 70% t-butylhydroperoxide overnight. Excess peroxide was decomposed with aqueous sodium hydrogen sulfite, and the residual toluene solution was extracted with water and evaporated to dryness, thereby obtaining a crude product. The crude product was then extracted with hexane, and the hexane solution was purified to give 1.9 g of the C545TP-capped poly(9,9-di-n-octylfluorene-2,7″-diyl). The Mw analyzed by GPC (gel permeation chromatography) was 32000.

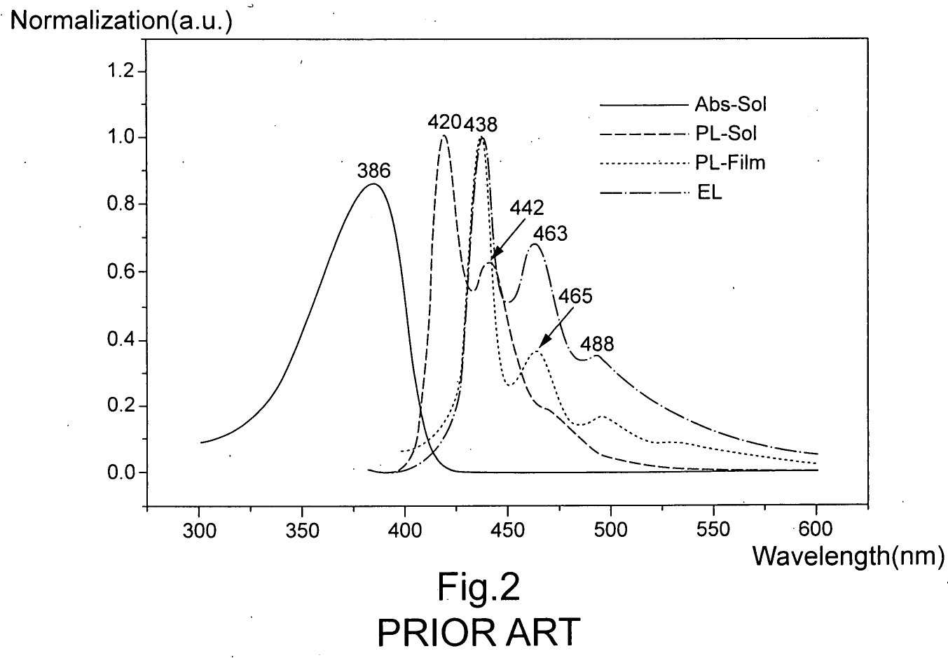

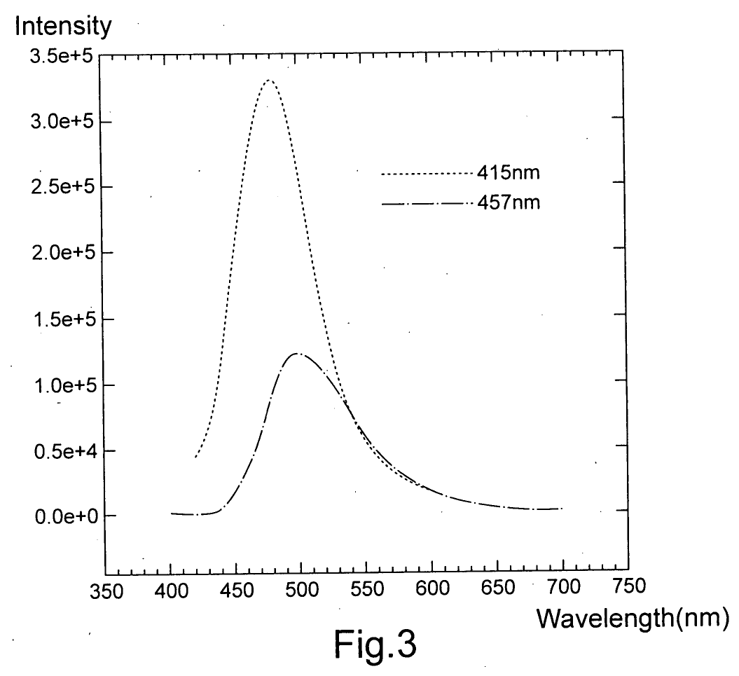

Please refer to FIGS. 2 and 3, which illustrate fluorescent spectra of a conventional polymer poly(9,9-di-n-octylfluorene-2,7″-diyl) and the light-emitting material C545TP-capped poly(9,9-di-n-octylfluorene-2,7″-diyl) according to an embodiment of the present invention, respectively. The maximum emissive wavelength (λₘₐₓ) of poly(9,9-di-n-octylfluorene-2,7″-diyl) is in the range of about 420-440 nm (for example, around 438 nm). Whereas, the maximum emissive wavelength (λₘₐₓ) of the light-emitting material C545TP-capped poly(9,9-di-n-octylfluorene-2,7″-diyl) is in the range of about 460-500 nm (for example, around 480 nm). In other words, by means of modification with the dye C545T, the original blue-emitting poly(9,9-di-n-octylfluorene-2,7″-diyl) is red-shifted by about 60-80 nm to a green-emitting material.

By means of a spin coating or an ink-inject printing process, the product C545TP-capped poly(9,9-di-n-octylfluorene-2,7″-diyl) can be applied onto an electric hole transport layer 12 of FIG. 1 as a light-emitting layer 13.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A light-emitting material, comprising:
a polymeric skeleton; and
a dye moiety linking to said polymeric skeleton by chemical bonding, and having an energy gap lower than that of said polymeric skeleton so that energy is transferred from said polymeric skeleton to said dye moiety when said light-emitting material is excited, thereby the light-emitting material emits light.

2. The light-emitting material according to claim 1 wherein said dye moiety links to a terminal of said polymeric skeleton.

3. The light-emitting material according to claim 1 wherein said dye moiety links to said polymeric skeleton by coupling.

4. The light-emitting material according to claim 1 wherein said polymeric skeleton comprises a polymeric or oligomeric fluorene.

5. The light-emitting material according to claim 4 wherein said polymeric skeleton comprises a repeating unit of the formula: 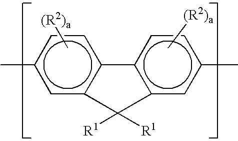
wherein R¹ is independently, in each occurrence, C₁₋₂₀ hydrocarbyl or C₁₋₂₀ hydrocarbyl containing one or more S, N, O, P or Si atoms, or both of R¹, together with the 9-carbon on the fluorene, may form a C₅₋₂₀ ring structure or a C₄₋₂₀ ring structure containing one or more S, N, or O atoms;
R² is independently, in each occurrence, C₁₋₂₀ hydrocarbyl, C₁₋₂₀ hydrocarbyloxy, C₁₋₂₀ thioether, C₁₋₂₀ hydrocarbyloxycarbonyl, C₁₋₂₀ hydrocarbylcarbonyloxy, or cyano; and
a is independently, in each occurrence, 0 or 1.

6. The light-emitting material according to claim 5, wherein R¹ is C₁₋₂₀ hydrocarbyl.

7. The light-emitting material according to claim 6, wherein R¹ is n-octyl, and a is 0.

8. The light-emitting material according to claim 1, wherein said polymeric skeleton is polyparaphenylene (PPP).

9. The light-emitting material according to claim 1 wherein said dye moiety is a radical comprising a dye selected from the group consisting of:

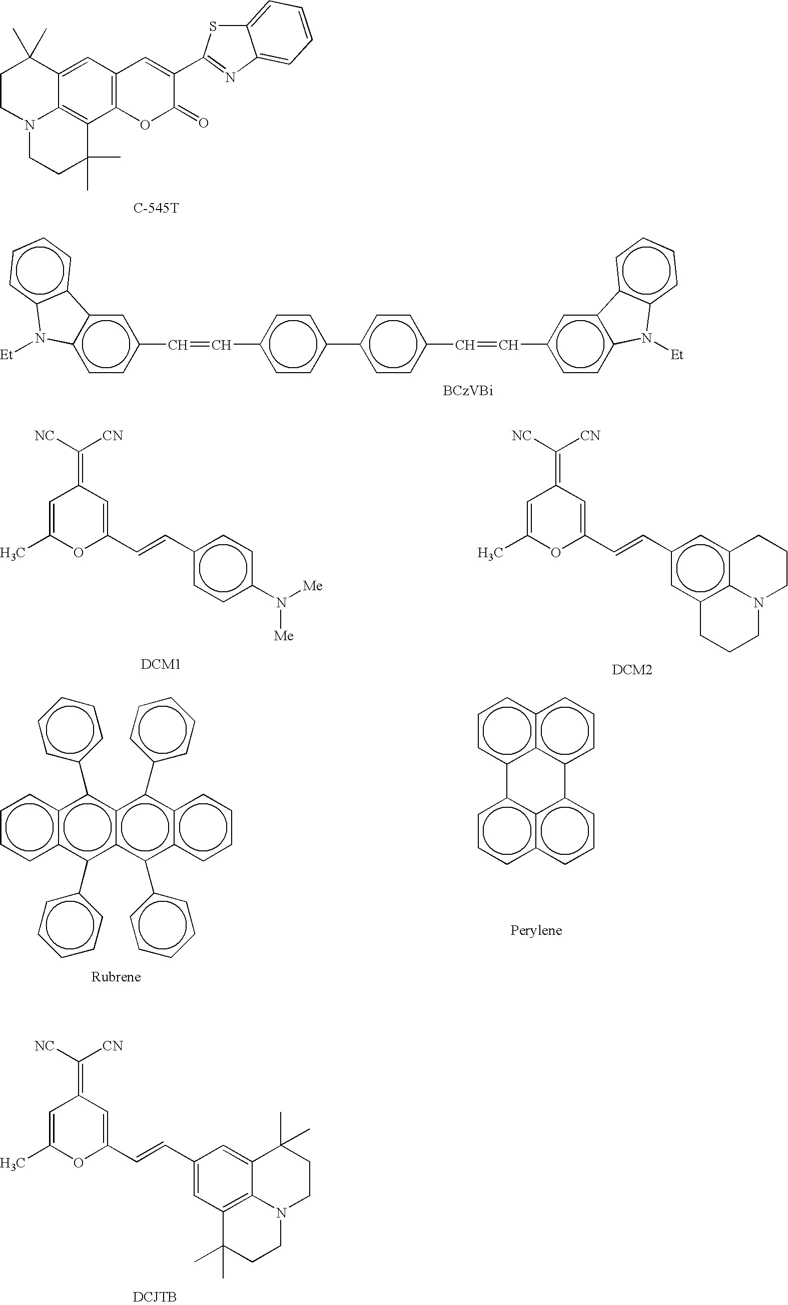

10. The light-emitting material according to claim 9 wherein said dye moiety is

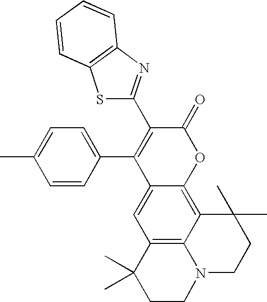

11. An electroluminescent device comprising:
a light transmissible electrode pair comprising an anode and a cathode; and
a light-emitting material layer disposed between said anode and said cathode, wherein the light-emitting material comprises a polymeric skeleton;
and a dye moiety linking to said polymeric skeleton by a chemical bonding, and having an energy gap lower than that of said polymeric skeleton so that energy is transferred from said polymeric skeleton to said dye moiety when said light-emitting material is excited, thereby the light-emitting material emits light.

12. A process for producing a light-emitting material, comprising steps of:
providing a dye molecule;
modifying the dye molecule to have a first terminal reactive group;
providing a monomer having a second terminal reactive group;
polymerizing the monomer to produce a polymer having the second terminal reactive group; and
reacting said modified dye molecule with said polymer by a reaction of the first terminal reactive group and the second terminal reactive group to produce a light-emitting material comprising a polymeric skeleton and a dye moiety linking to said polymeric skeleton.

13. The process as claimed in claim 12, wherein the dye molecule is selected from the group consisting of

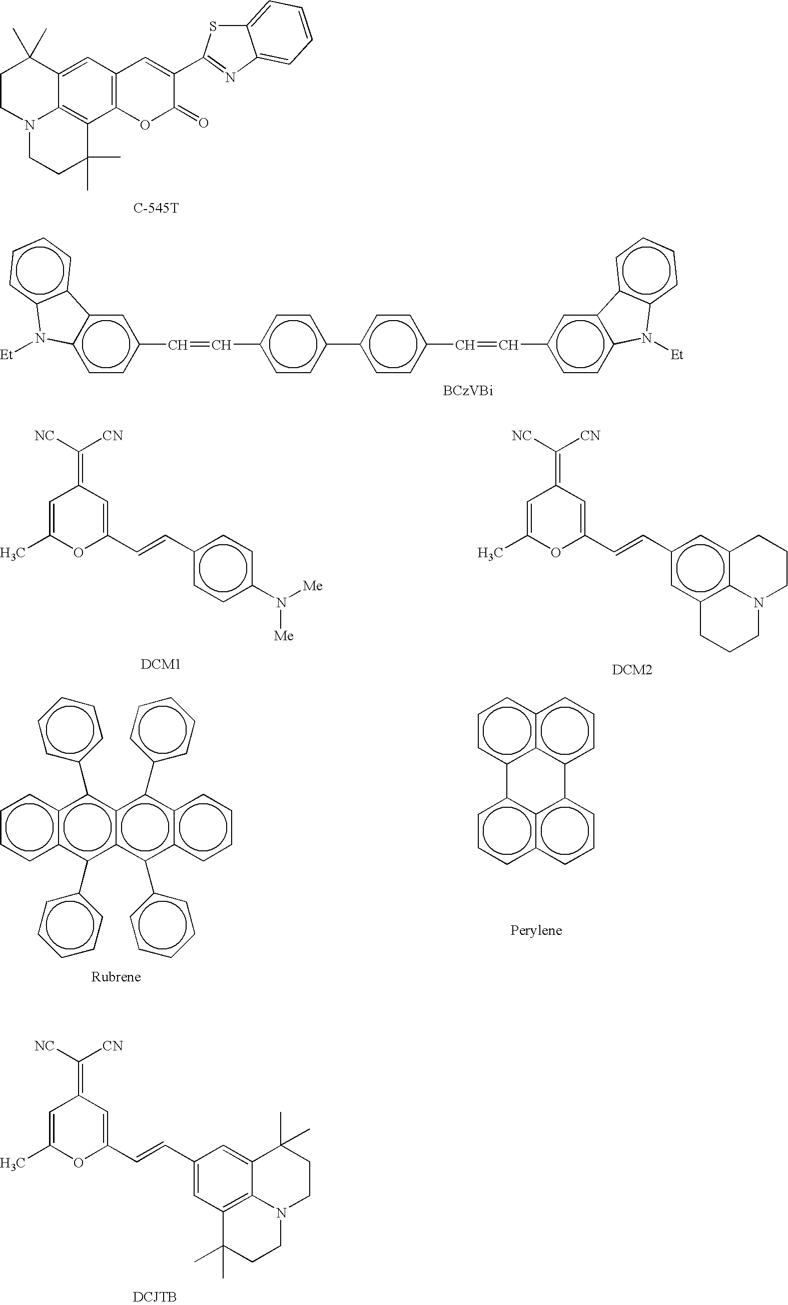

14. The process as claimed in claim 12, wherein the first terminal reactive group comprises halogen.

15. The process as claimed in claim 12, wherein the monomer is 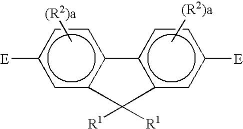
wherein R¹ is independently, in each occurrence, C₁₋₂₀ hydrocarbyl or C₁₋₂₀ hydrocarbyl containing one or more S, N, O, P or Si atoms, or both of R¹, together with the 9-carbon on the fluorene, may form a C₅₋₂₀ ring structure or a C₄₋₂₀ ring structure containing one or more S, N, or O atoms;
R² is independently, in each occurrence, C₁₋₂₀ hydrocarbyl, C₁₋₂₀ hydrocarbyloxy, C₁₋₂₀ thioether, C₁₋₂₀ hydrocarbyloxycarbonyl, C₁₋₂₀ hydrocarbylcarbonyloxy, or cyano;
a is independently, in each occurrence, 0 or 1; and
E is independently a second terminal reactive group.

16. The process as claimed in claim 15, wherein E is halogen.

17. The process as claimed in claim 15, wherein R¹ is C₁₋₂₀ hydrocarbyl.

18. The process as claimed in claim 15, wherein the monomer is 2,7-dibromo-9,9-di-n-octylfluorene.

19. The process as claimed in claim 12, wherein the polymer is a polyparaphenylene (PPP) having a second terminal reactive group.

20. The process according to claim 12, wherein the emission wavelength of said polymer is shorter than that of said dye molecule.
